(19) United States
(12) Patent Application Publication
(10) Pub. No.: US 2008/0094834 A1
(43) Pub. Date: Apr. 24, 2008

(54) Illuminating Display Device

(76) Inventors: Hung-Mau Li, Yung Ting Township (TW); Yun-Ju Li, Yung Ting Township (TW)

Correspondence Address: HDSL, 4331 STEVENS BATTLE LANE, FAIRFAX, VA, 22033, US

(21) Appl. No.: 11/551,781

(22) Filed: Oct. 23, 2006

(51) Int. Cl. F21V 1/00

(52) U.S. Cl. 362/241

(57) ABSTRACT

An illuminating display device is capable of forming multiplex formative and is widely used, which includes a plurality of continuous illuminating units having a shearable solid base, each base forms a concave optical concentrating portion disposed at a surface thereof, and a reflective layer is disposed at a top portion of the concave optical concentrating portion. Each of the illuminating units includes an illuminating member disposed at the reflective layer, and each of the illuminating units may be series or parallel connected. With these configurations, the user may shear the illuminating display device at different patterns according to the needs. The reflective layer may improve the utilization efficiency and increase the identifiable distance of the illuminating display device, which enable the illuminating display device to be widely used in advertisements, texts, logos, road billboards, license plate, or the like.

### BACKGROUND

The present invention relates to illuminating devices employed in billboards, and more particularly to an illuminating display device, which is widely used and be capable of being sheared to different patterns.

Nowadays, the illuminating devices are employed in the advertisements, the signboards, or the logos for illuminating the solid texts and patterns thereof so as to make the advertisements, the signboards, or the logos to be distinctly exhibited on the evening or in obscure environments. There are three types of conventional illuminating ways of the illuminating devices: the first type is projection; the second type is build-in; and the third type is disposing illuminant at edge portions.

Firstly, according to the projection type, the light beams emitted by the projecting lamps are liable to be reflected by the material of the advertisements, the signboards, or the logos. Moreover, the projecting lamps with great volume disposed in front of the advertisements, the signboards, or the logos may impact the utilization efficiency of the space and the aesthetic feelings. Secondly, the build-in type illuminating devices are only fit for the advertisements, the signboards, or the logos with transparent materials, otherwise, the light beams emitted by the build-in type illuminating devices may be astigmatic, and the illuminating result are degenerated. Thirdly, neon lights are typical disposing illuminant at edge portions type illuminating devices, which may impact the design of the advertisements, the signboards, or the logos, and are not fit for the office rooms, or the like.

Thus it can be seen, the advertisements, the signboards, or the logos with the conventional illuminating devices can not achieve an ideal illuminating display result, and the identifiable distance thereof are short. Furthermore, the flexibility and the variation of the illuminating devices employed in the advertisements, the signboards, or the logos are limited, that is, the conventional illuminating devices are used in a fixed form, then the pattern of the advertisements, the signboards, or the logos can not be evenly illuminated.

Accordingly, what is needed is an illuminating display device that can overcome the above-described deficiencies.

### BRIEF SUMMARY

An exemplary illuminating display device is capable of being sheared to all kinds of patterns, and is widely used in advertisements, logos, roar bill boards, or the like.

On an aspect, the illuminating display device includes a plurality of continuous illuminating units having a shearable integrated base, the base includes a concave optical concentrating portion disposed at a middle portion thereof, at least one containing through hole disposed at a side surface thereof, and a reflective layer disposed at a top portion of the concave optical concentrating portion. Each of the illuminating units includes at least one illuminating member disposed at the reflective layer. And an outlet is disposed in the through hole and is connecting to the at least one illuminating member for connecting with a plug.

On another aspect, the illuminating display includes a plurality of continuous illuminating units having a shearable solid base, and the base includes a concave optical concentrating portion disposed at a surface thereof, and a reflective layer disposed at a top portion of the concave optical concentrating portion. Each of the illuminating units includes at least one illuminating member disposed at the reflective layer. The base further includes at least one containing through hole disposed at a side surface thereof corresponding to the at least one illuminating member. And an outlet is disposed in the through hole and is connecting to the at least one illuminating member for connecting with a plug.

With these configurations, the user may shear the illuminating display device at different patterns according to the needs. The reflective layer may improve the utilization efficiency and increase the identifiable distance of the illuminating display device, which enable the illuminating display device to be widely used in advertisements, texts, logos, road billboards, license plate, or the like.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an abbreviated, perspective view of an illuminating display device according to an exemplary embodiment of the present invention;

FIG. 2 is an exploded view of the illuminating display device of FIG. 1, showing the elements and the relationship thereof;

FIG. 3 is a bottom view of the illuminating display device of FIG. 1;

FIG. 4 is a perspective view of part of the illuminating display device of FIG. 1;

FIG. 5 is a cross-sectional view of the illuminating display device of FIG. 1;

FIG. 6 is an exploded view of the illuminating display device of FIG. 1, showing the illuminating display device in an operation state;

FIG. 7 is an assembled view of the illuminating display device of FIG. 1, showing the illuminating display device in an operation state;

FIG. 8 is a schematic view of circuits of the illuminating display device of FIG. 1; showing the illuminating display device in an operation state;

FIG. 9 is an exploded view of an illuminating display device according to another embodiment of the present invention; and

FIG. 10 is a cross-sectional view of an illuminating display device of FIG. 9.

### DETAILED DESCRIPTION

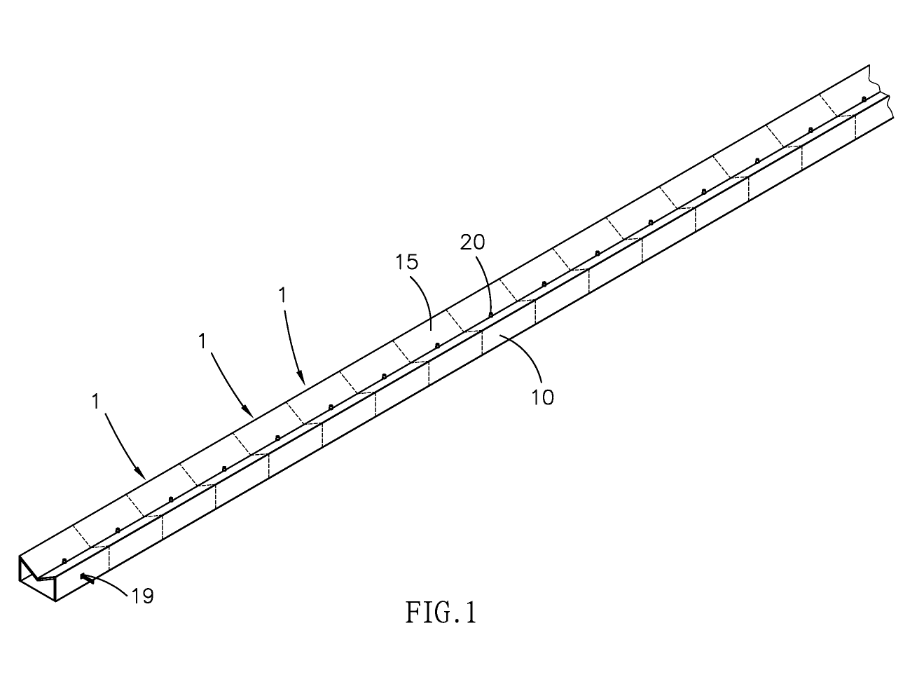

Referring to FIG. 1, an abbreviated, perspective view of an illuminating display device according to an exemplary embodiment of the present invention is shown. The illuminating display device includes a plurality continuous illuminating units 1 having a base 10, and each of the illuminating units 10 includes a illuminating member 20. The illuminating members 20 may individually conduct, or parallel or series connect with each other. The base 10 is integrated, which is conveniently to be sheared.

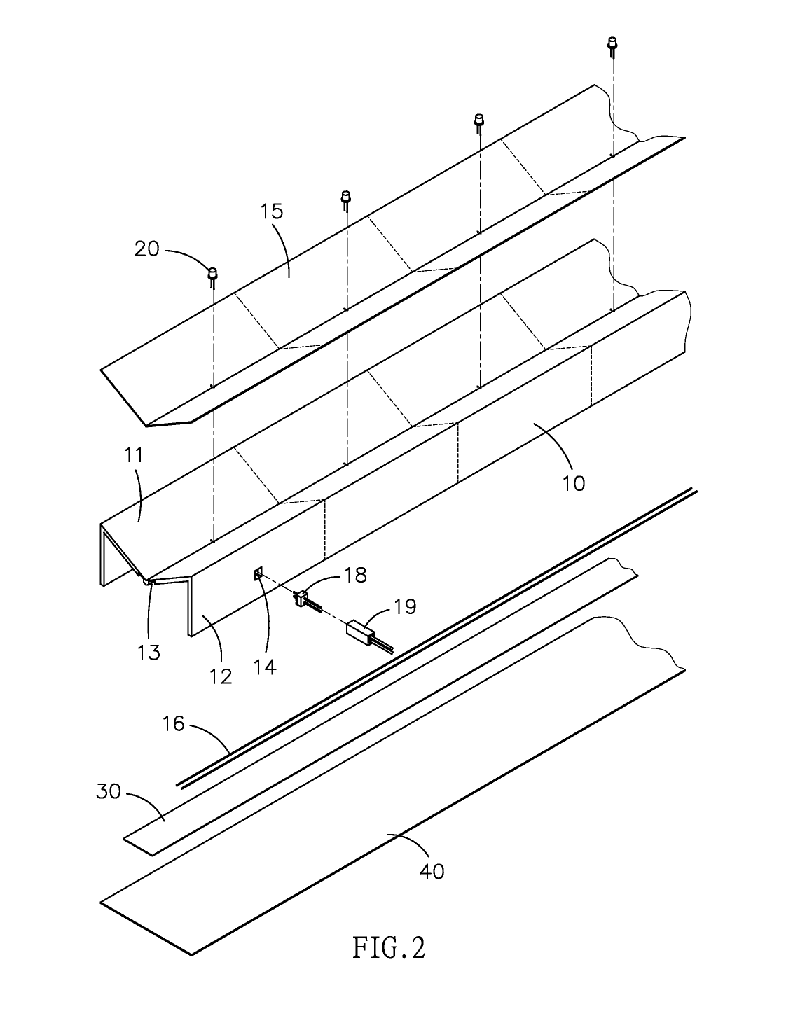

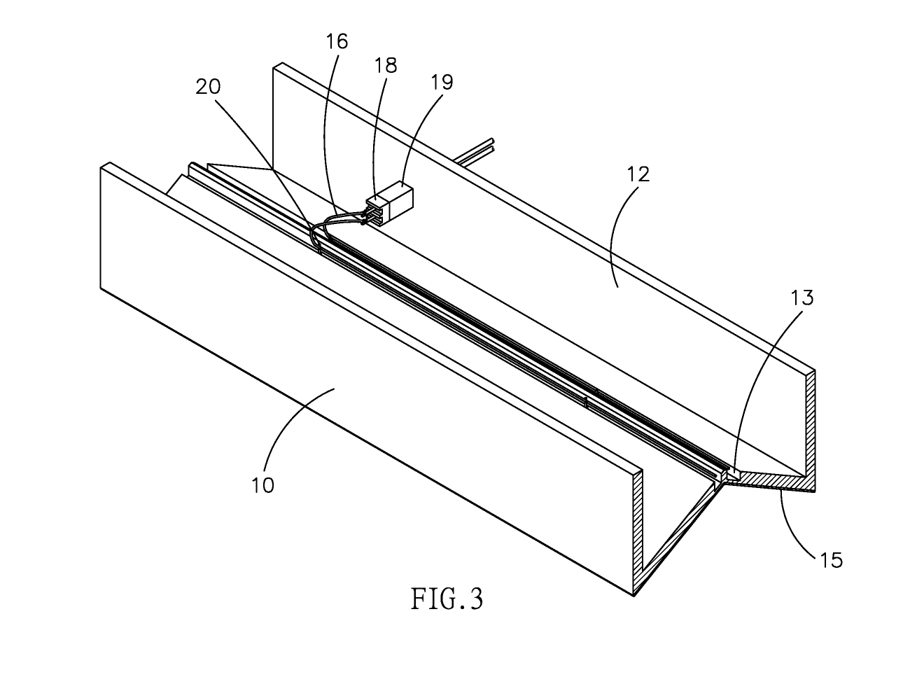

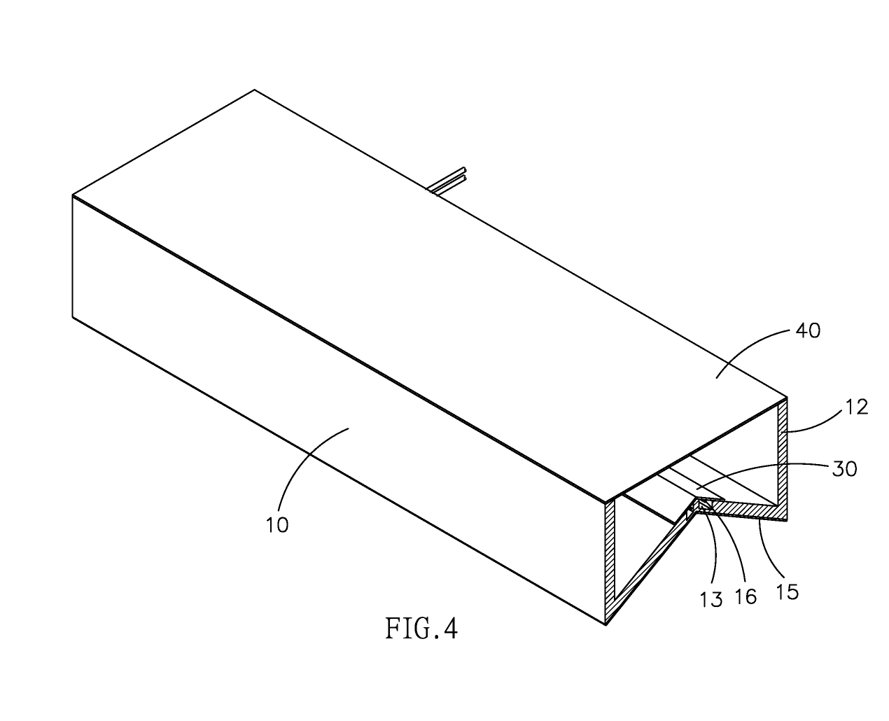

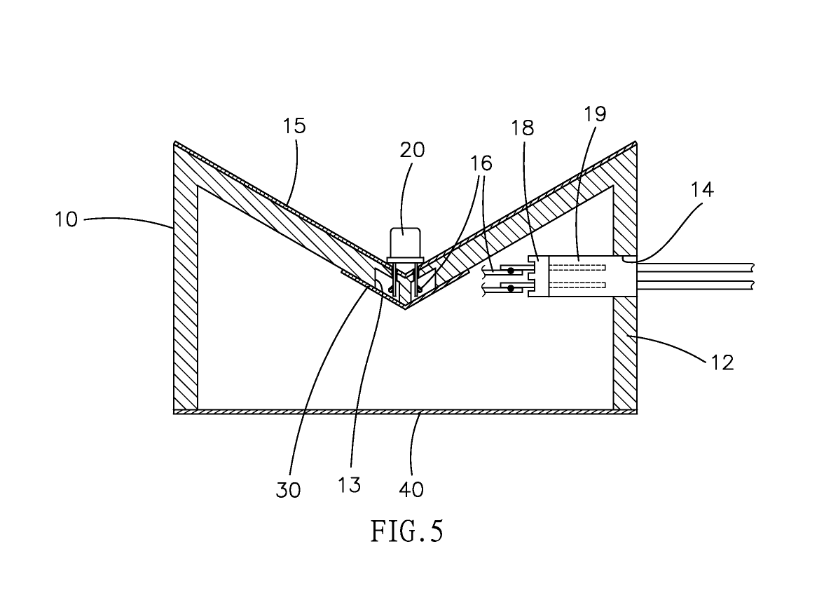

Also referring to FIGS. 2 to 5, the base 10 has a thin piece shaped, which form a concave optical concentrating portion 11 at a middle portion of the base 10, the optical concentrating portion includes two piece portions extended from opposite ends of the optical concentrating portion respectively so as to form two supporting members. The base 10 includes at least one groove 13 disposed at an inner surface of the bottom portion of the base 10 corresponding to the optical concentrating portion 11, at least one containing through hole 14 disposed at a side surface of the base 10, a reflective layer 15 disposed at a top portion of the optical concentrating portion 11. The reflective layer 15 may be a reflective paper attached to a top portion of the optical concentrating portion 11, or a coating having reflective lacquer that is coated at the optical concentrating portion 11. In this embodiment, the reflective layer 15 is a reflective paper. A lead 16 is contained in the groove 13. The lead 16 may be parallel or series connected with the illuminating member 20, parallel connected is preferred. An outlet 18 is disposed in the containing through hole 14 and is connecting with the lead, which may connects with a plug 19.

The illuminating member 20 is disposed on the reflective layer 15, and the pins of which are connected with the lead 16. The base 10 further includes a cover piece 30 disposed at an inner surface of the bottom portion thereof corresponding to the groove 13 for covering lead 16 to increase the aesthetic feelings and prevent the lead 16 from loosening. In addition, the base 10 includes a bottom plate 40, which may cover the bottom of the base 10 so as to enable the base 10 to be attached to a surface of a matter.

With these configurations, the illuminating display device may be sheared to all kinds of patterns, and the identifiable distance is increased. The base 10 may be made of a material of one of rubber, silicon glue, silicon rubber, plastic, and metal.

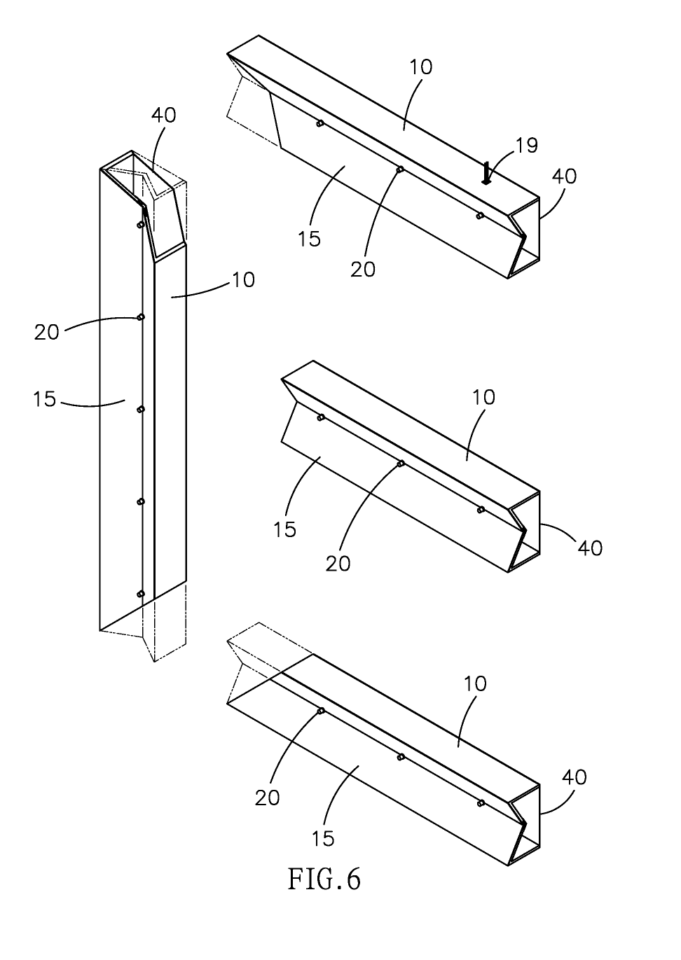

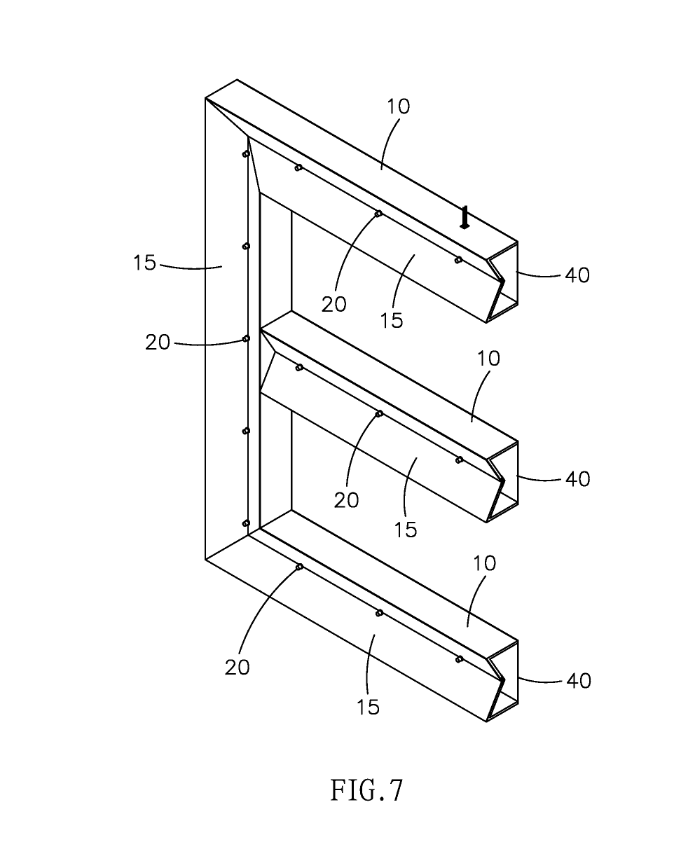

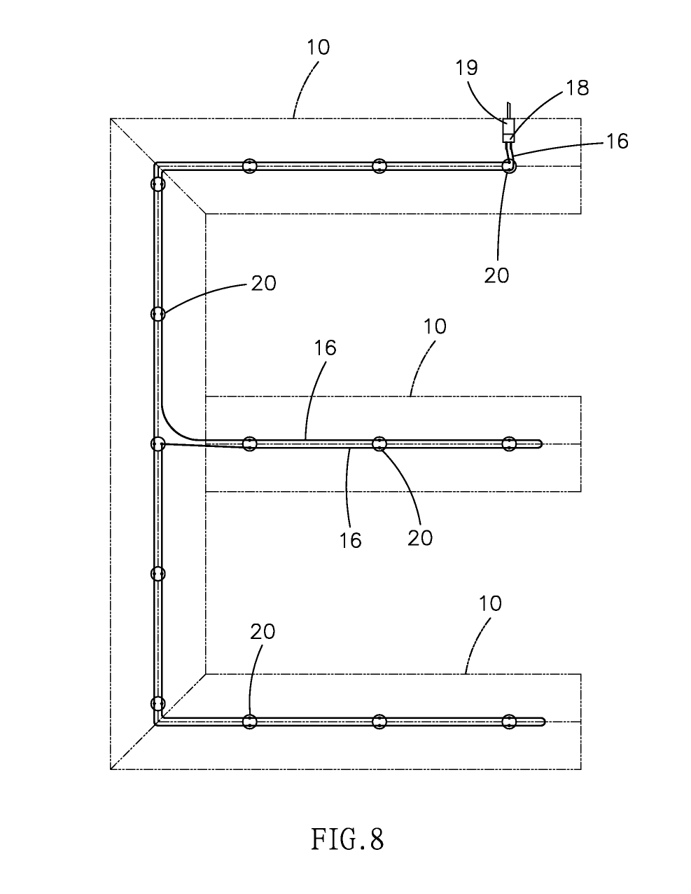

In operation, for example, the illuminating units 1 of the illuminating display device are sheared and are cooperative with each other to form letter E. Referring to FIGS. 6 to 8, the illuminating display device includes three horizontal portions and a vertical portion formed by series connected illuminating units 1. One end of each of the horizontal portions is engaged with the vertical portion. The lead 16 of the illuminating members 20 are parallel or series connected (shown in FIG. 8) so as to form the pattern as needed. The reflective layer 15 on the optical concentrating portions 11 may reflect and forwardly concentrate the light beams emitted by the illuminating members 20 so as to increase the identifiable distance of the advertisements, the logos, the billboards that employed this illuminating display device.

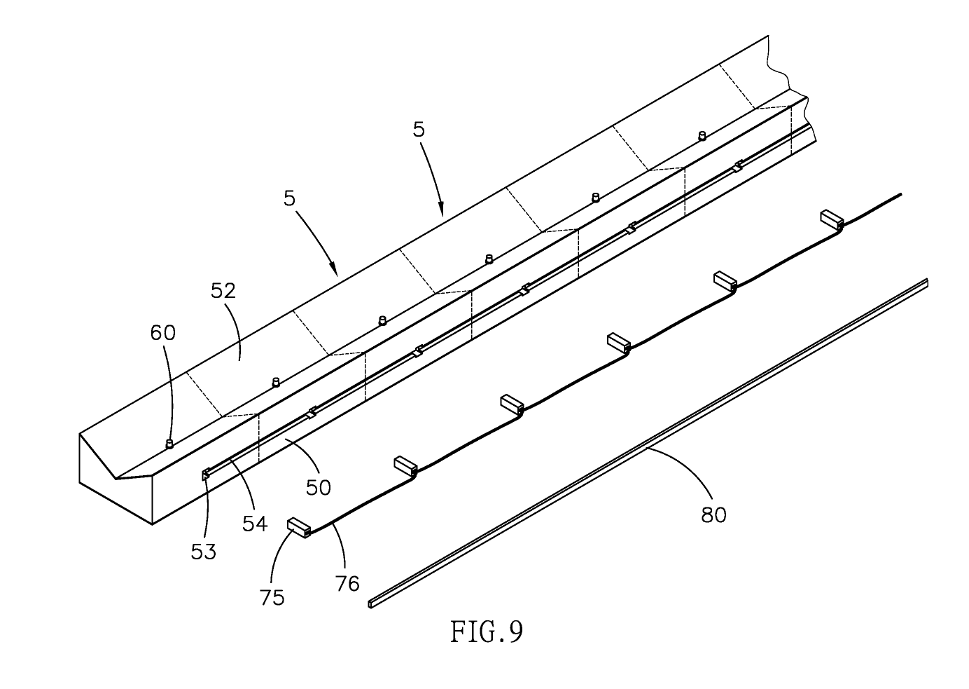

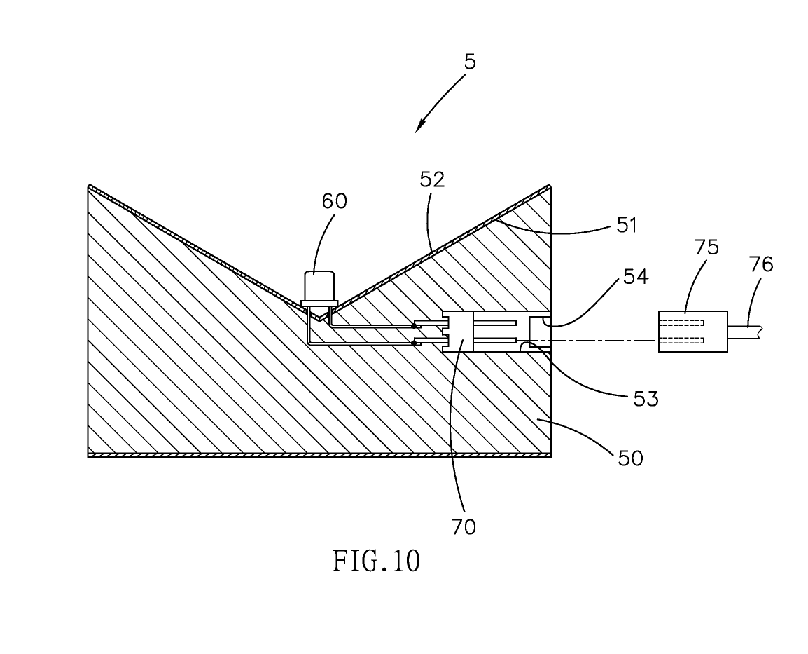

Referring to FIGS. 9 and 10, an exploded view and a cross-sectional view of an illuminating display device according to another embodiment of the present invention is shown. The illuminating display device is formed by a plurality of continuous illuminating units 5, which includes a shearable solid base 50, the base 50 includes a concave optical concentrating portion 51 disposed at a surface thereof, and a reflective layer 52 disposed at a top portion of the concave optical concentrating portion 51. Each of the illuminating units 5 includes at least one illuminating member 60 disposed at the reflective layer 52. The reflective layer 52 may be a reflective paper attached to a top portion of the optical concentrating portion 51, or a coating having reflective lacquer that is coated at the optical concentrating portion 51. In this embodiment, the reflective layer 52 is a reflective paper. The base 50 includes a containing through hole 53 disposed at a side surface thereof corresponding to the illuminating member 60, and a lead groove 54 is disposed between each two adjacent containing through holes 53. And an outlet 70 is disposed in the through hole 53 and is connecting to the illuminating member 60 for connecting with a plug 75. And each two adjacent plugs 75 are series connected by a lead 76, and the lead 76 is contained in the lead groove 54 of the base 50. The base 50 further includes a cover piece 80 disposed at a side surface thereof for covering the lead groove 54 so as to prevent the plugs 75 from loosening. This illuminating display device may also be sheared to all kinds of patterns, and the identifiable distance is increased.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An illuminating display device, comprising:
a plurality of continuous illuminating units comprising a shearable integrated base, the base comprising a concave optical concentrating portion disposed at a middle portion thereof, at least one containing through hole disposed at a side surface thereof, and a reflective layer disposed at a top portion of the concave optical concentrating portion; and
wherein each of the illuminating units comprises at least one illuminating member disposed at the reflective layer, and an outlet is disposed in the through hole and is connecting to the at least one illuminating member for connecting with a plug.

2. The illuminating display device as claimed in claim 1, wherein the optical concentrating portion comprises two piece portions extended from opposite ends of the optical concentrating portion respectively, for forming two supporting portions.

3. The illuminating display device as claimed in claim 1, wherein the reflective layer comprises one of a reflective paper and a coating having reflective lacquer.

4. The illuminating display device as claimed in claim 1, wherein the base is made of a material of one of rubber, silicon glue, silicon rubber, plastic, and metal.

5. The illuminating display device as claimed in claim 1, wherein the base comprises at least one lead disposed at a bottom portion of the base, and the lead is connecting with the illuminating members of the illuminating units.

6. The illuminating display device as claimed in claim 5, wherein the base comprises at least one groove disposed at an inner surface of the bottom portion thereof corresponding to the optical concentrating portion for containing the at least one lead.

7. The illuminating display device as claimed in claim 6, wherein the base comprises a cover piece disposed at an inner surface of the bottom portion thereof for covering the at least one lead.

8. The illuminating display device as claimed in claim 1, wherein the base comprises a bottom plate covering a bottom portion of the base.

9. An illuminating display device, comprising:
a plurality of continuous illuminating units having a shearable solid base, the base comprising a concave optical concentrating portion disposed at a surface thereof, and a reflective layer disposed at a top portion of the concave optical concentrating portion; and
wherein each of the illuminating units comprises at least one illuminating member disposed at the reflective layer, and the base comprises at least one containing through hole disposed at a side surface thereof corresponding to the at least one illuminating member, and an outlet is disposed in the through hole and is connecting to the at least one illuminating member for connecting with a plug.

10. The illuminating display device as claimed in claim 9, wherein the reflective layer comprises one of a reflective paper and a coating having reflective lacquer.

11. The illuminating display device as claimed in claim 9, wherein the base is made of a material of one of rubber, silicon glue, silicon rubber, plastic, and metal.

12. The illuminating display device as claimed in claim 9, further comprising a lead groove disposed between each two adjacent containing through holes, and each two adjacent plugs are series connected by a lead, and the lead is contained in the lead groove.

13. The illuminating display device as claimed in claim 12, wherein the base comprises a cover piece disposed at a side surface thereof for covering the lead groove.
